(19) United States
(12) Patent Application Publication
(10) Pub. No.: US 2017/0131489 A1
(43) Pub. Date: May 11, 2017

(54) ELECTRICAL CONNECTOR ASSEMBLY AND SYSTEM USING TERAHERTZ TRANSMISSION

(71) Applicant: FOXCONN INTERCONNECT TECHNOLOGY LIMITED, Grand Cayman (KY)

(72) Inventors: KUEI-CHUNG TSAI, New Taipei (TW); LI-CHUN WU, New Taipei (TW)

(21) Appl. No.: 15/348,988

(22) Filed: Nov. 11, 2016

Related U.S. Application Data
(60) Provisional application No. 62/253,697, filed on Nov. 11, 2015.

(51) Int. Cl. G02B 6/42

(52) U.S. Cl. CPC G02B 6/428; G02B 6/4214; G02B 6/4284

(57) ABSTRACT

A connector assembly includes a printed circuit board (PCB) enclosed within a metallic cover. The PCB has an exposed mating port at a front region, and a transmission region around a rear region. A latch structure associated with a pulling tape is provided on the metallic cover. A CMOS (Complementary Metal-Oxide-Semiconductor) IC and a control IC are mounted upon the PCB and electrically connected to the mating port for transforming the electrical signal to the THz electromagnetic waves. An optional lens is optionally located at the rear region to refocus the THz electromagnetic waves to a low dielectric constant wave guide for further transmission. A system includes a pair of connector assemblies oppositely arranged and linked with each other via the low dielectric constant wave guide.

### BACKGROUND OF THE INVENTION

1. Field of the Invention

The present invention relates generally to an electrical connector assembly, more particularly to the cable connector carrying Terahertz (THz) electromagnetic waves.

2. Description of Related Arts

The traditional optoelectronic assembly includes a printed circuit board (PCB) equipped with the active component, e.g., the vertical-cavity surface-emitting laser (VCSEL) or PIN (p-doped-intrinsic-n-doped) photodetectors, and integrated circuit (IC) linked by the wire-bond. Firstly, the wire-bond is slender with high resistance thereof, thus resulting in high inductance which is not fit for high frequency transmission. Secondly, via such wire-bonds, it is required to have both the active component and IC face up so as to have the heat-dissipation surfaces of both the component and the IC directly seated upon the printed circuit board, thus jeopardizing the efficiencies of the heat dissipation thereof. Thirdly, because the active component and IC face up, the corresponding lens is required to be seated upon/above the active component, thus hindering inspection of the interior size, current and voltage of the active component and the corresponding repairing and adjustment if the VCSEL becomes defective. It is not only the structural manufacturing problem but also the relatively high component cost. Therefore, it is desired to have other solution for transmitting the electrical signals instead optical transmission. In this invention, the Terahertz electromagnetic wave is used to implement this transmission.

### SUMMARY OF THE INVENTION

A connector assembly comprises a printed circuit board (PCB) enclosed within a metallic cover. The PCB has an exposed mating port at a front region, and a transmission region around a rear region. A latch structure associated with a pulling tape is provided on the metallic cover. A CMOS (Complementary Metal-Oxide-Semiconductor) IC and a control IC are mounted upon the PCB and electrically connected to the mating port for transforming the electrical signal to the THz electromagnetic waves. An optional lens is optionally located at the rear region to refocus the THz electromagnetic waves to a low dielectric constant wave guide for further transmission. A system includes a pair of connector assemblies oppositely arranged and linked with each other via the low dielectric constant wave guide.

### BRIEF DESCRIPTION OF THE DRAWING

FIG. 1 shows the traditional electro-optical assembly;

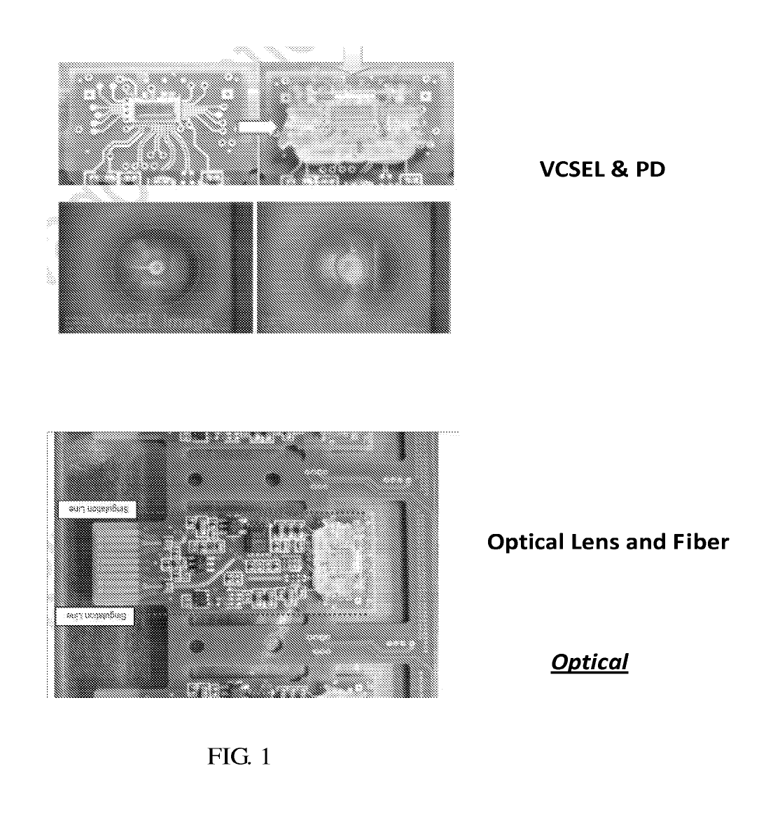

FIG. 2 is a perspective view of the wave cable for using with the THz transmission;

FIG. 3 is the traditional electro-optical connector cable assembly;

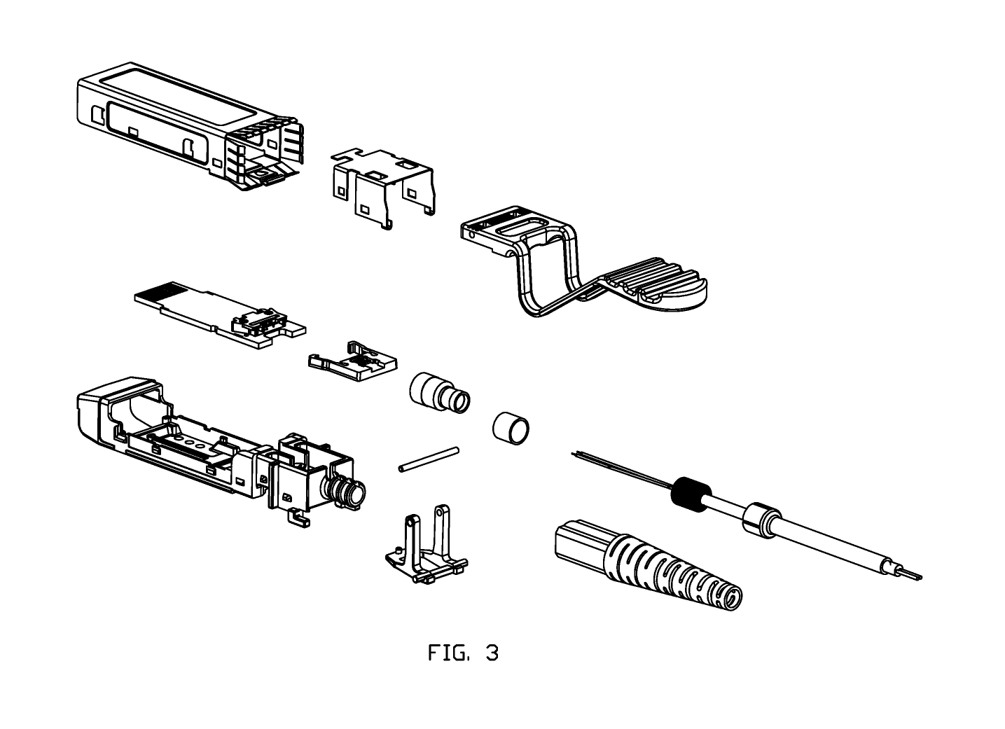

FIG. 4 is a diagram showing information of THz;

FIG. 5 shows the basic structure and theory of the THz transceiver and receiver;

FIG. 6 shows a system using the traditional method (the top one), and the invention (the middle one and the bottom one);

FIG. 6(A) is a perspective view showing the basic structure of a first embodiment of the invention wherein the dimension and the configuration is adopted from the electro-optic cable connector for illustration only;

FIG. 6(B) is a perspective view showing the basic structure of a second embodiment of the invention wherein the dimension and the configuration is adopted from the electro-optic cable connector for illustration only;

FIG. 7 is a diagram showing another application; and

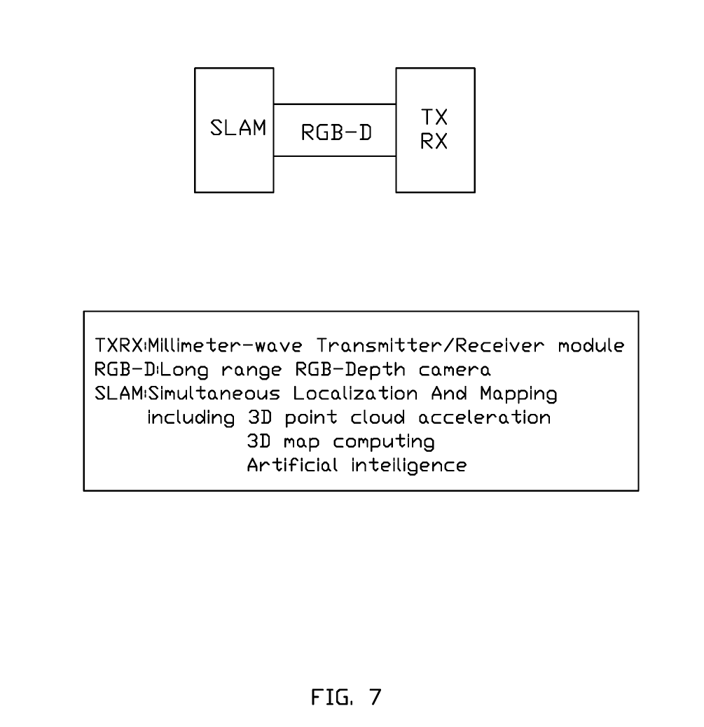

FIG. 8 is a diagram showing the system implementing the application of FIG. 7.

### DETAILED DESCRIPTION OF THE PREFERRED EMBODIMENT

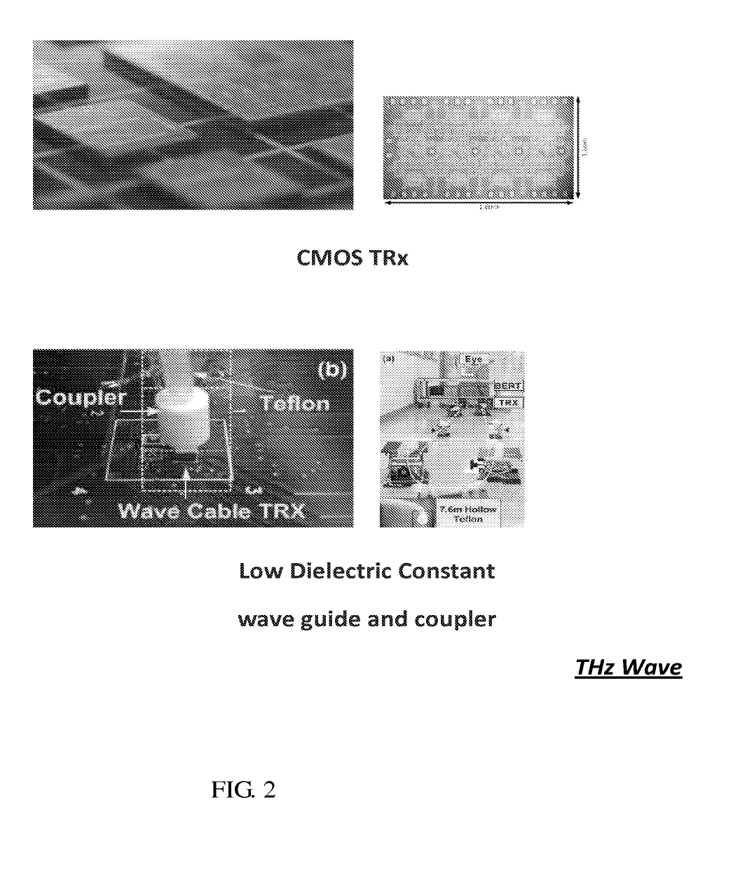

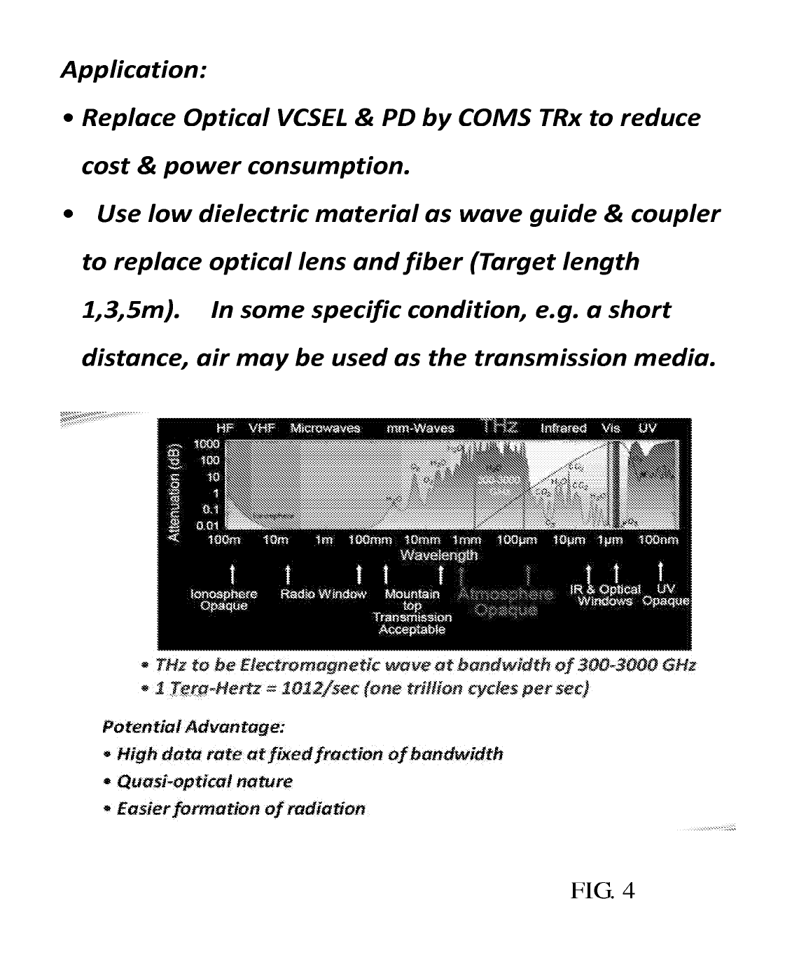

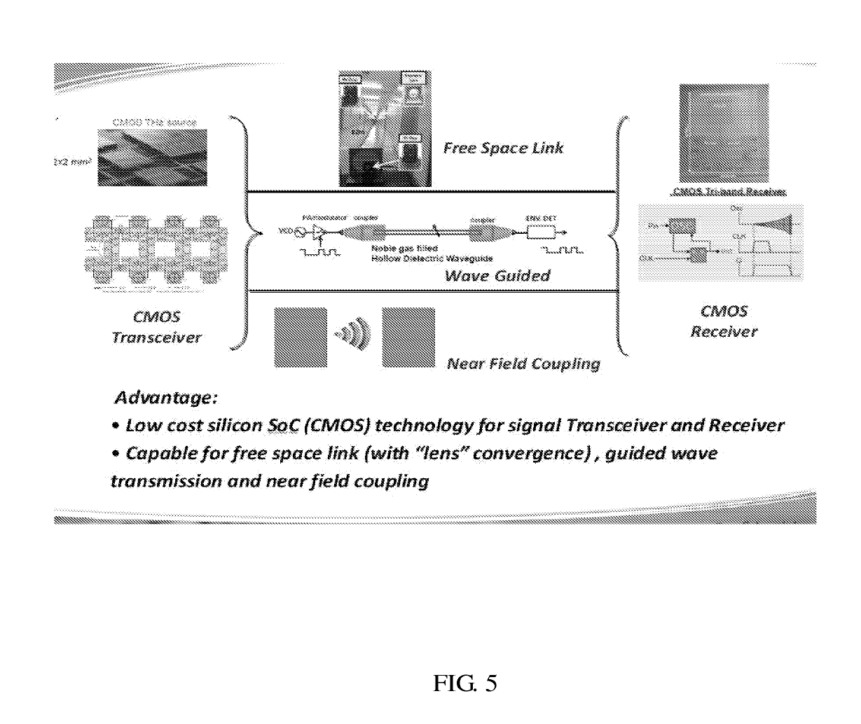

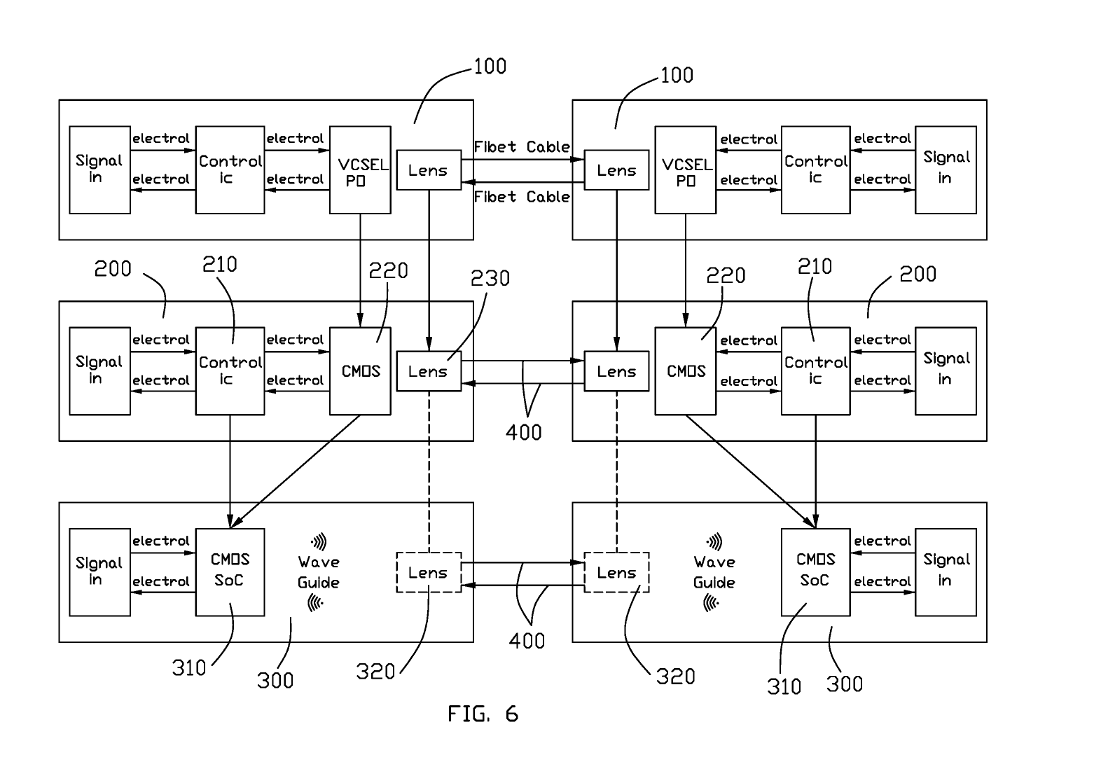

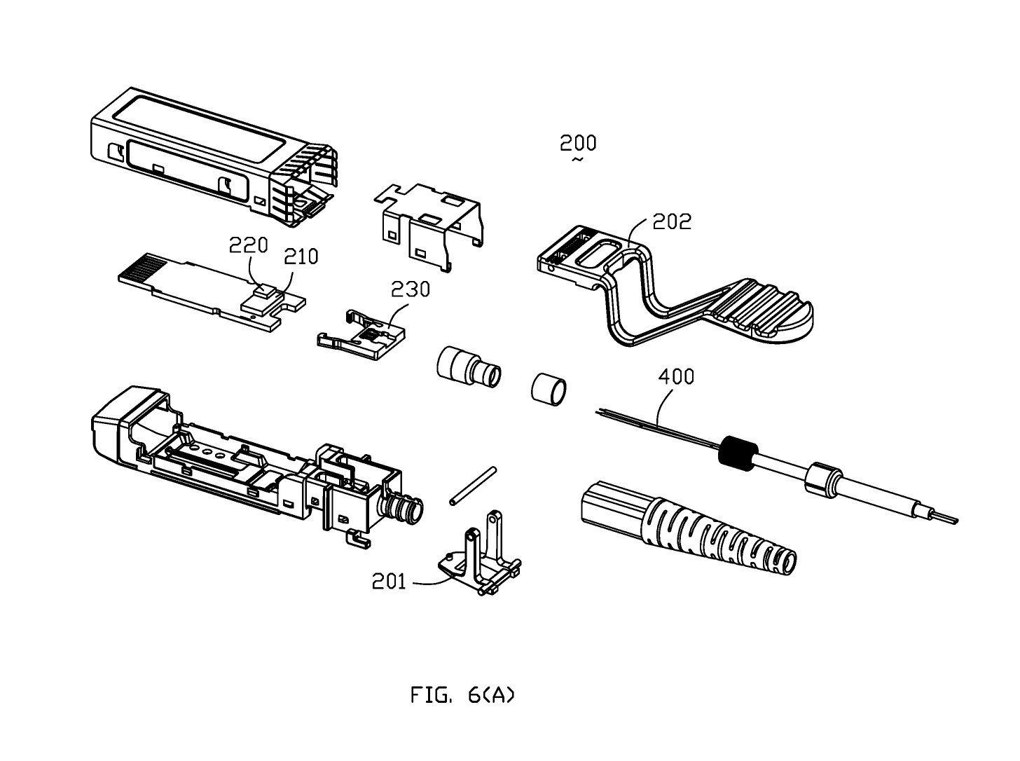

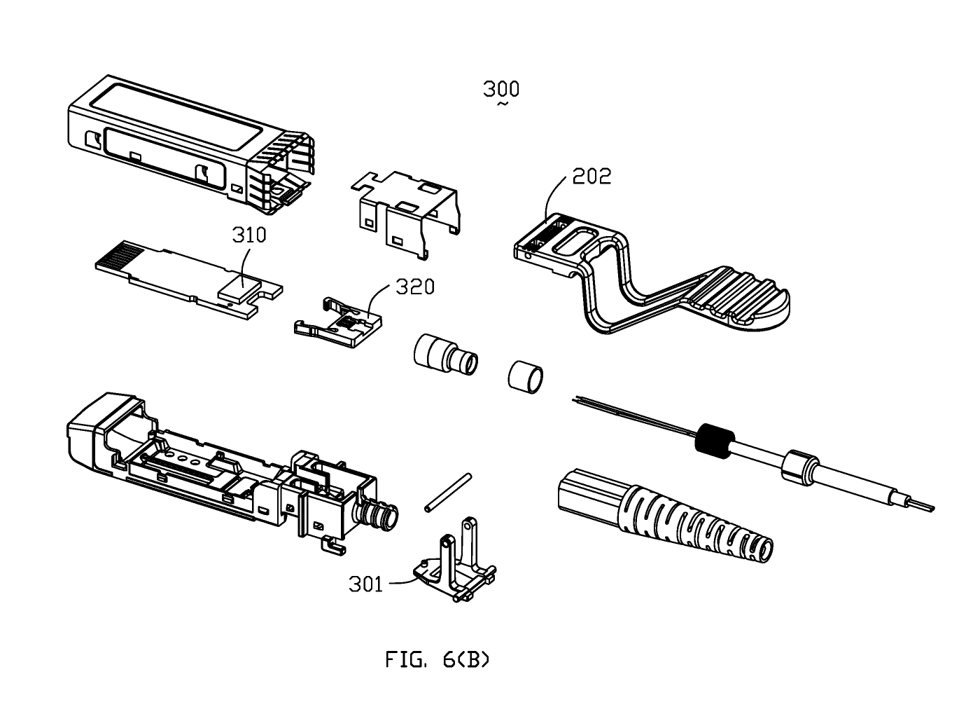

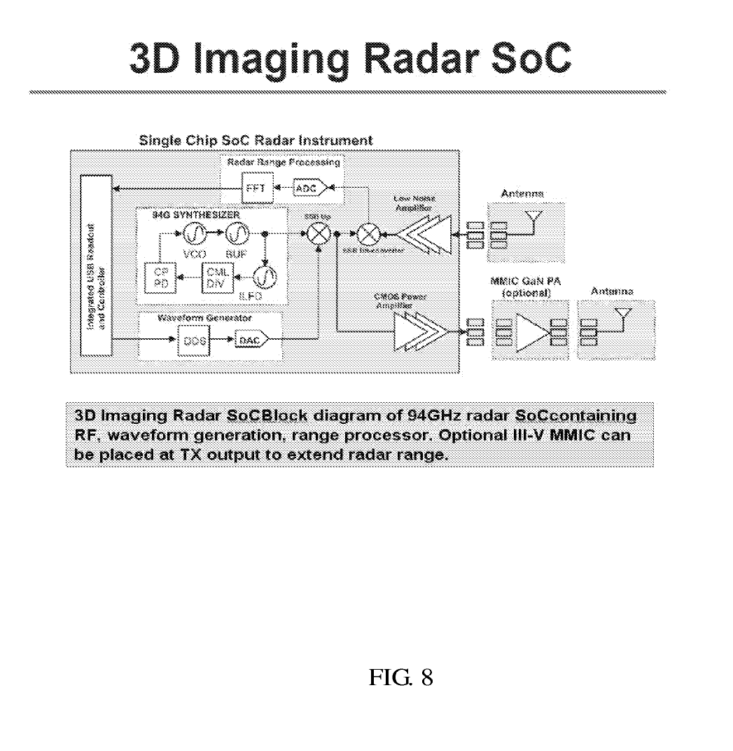

FIG. 2 shows the coupler or lens proximate the CMOS IC to efficiently capture the generated THz (electromagnetic waves) and redirect THz into a low dielectric constant waveguide, e.g. of Teflon material, wherein in this embodiment the waveguide is tubular, and the coupler is coupled to the CMOS IC along a vertical direction perpendicular to the PCB. FIG. 4 illustrates the advantages of THz. FIG. 5 illustrates how the system works. FIG. 6 shows comparison between the traditional electro-optic method 100 and the electro-THz method 200, 300 wherein the first embodiment 200 have the control IC 210 and the CMOS IC 220 separated from each other with a lens 230 associated therewith while the second embodiment 300 showing the next generation THz application have them (control IC and CMOS IC) 310 integrated together with or without the lens associated therewith. The THz signal is transmitted between two lens 230, 320 by waveguide 400 having low dielectric constant such as Teflon or other suitable material. FIGS. 6(A) and 6(B) show the first embodiment 200 and the second embodiment 300, respectively wherein the basic structures including the latch mechanism 201, 301 and the pulling tape 202, 302 can be referred to U.S. Pat. No. 8,597,045. In FIG. 6(A), the CMOS IC 220 shown above the lens 230, should be under the lens 230, similar to the VCSEL under the lens in the traditional electro-optic cable connector assembly 100, and the lens 230 may provide a 45-degree reflection surface to redirect the THz electromagnetic waves toward the corresponding waveguide 400 in the horizontal direction. In this instance, the flexible tubular low dielectric constant waveguide 400 analogous to the optical cable in the traditional optical cable, extends rearwardly at the rear region of the PCB and receives the THz electromagnetic waves for transmission. Understandably, because the THz also plays a wave radiation performance significantly, the 45-degree reflection structure of the lens 230 or even the lens 320 itself may not be required as shown in FIG. 6(B). Compared with the electro-optic cable connector assembly 100, the electro-THz connector assembly 300 may not require the severe tolerance on the arrangement of the related structures for light alignment between the related components, advantageously. As long as efficiently collecting the THz electromagnetic waves proximate the CMOS IC 310, the tubular waveguide 400 may efficiently transmit such THz electromagnetic waves easily. FIGS. 8 and 9 illustrate another application for position identifying and distance measuring.

What is claimed is:

1. A connector assembly comprising:
a printed circuit board (PCB) enclosed within a metallic cover, the PCB having an exposed mating port at a front region, and a transmission region around a rear region;
a latch structure associated with a pulling tape provided on the metallic cover;
a CMOS (Complementary Metal-Oxide-Semiconductor) IC and a control IC mounted upon the PCB and electrically connected to the mating port for transforming the electrical signal to the THz electromagnetic waves; and
an optional lens optionally located at the rear region to refocus the THz electromagnetic waves to a low dielectric constant wave guide for further transmission.

2. The connector assembly as claimed in claim 1, wherein said CMOS IC and said control IC are unified within one chip.
